(19) United States
(12) Patent Application Publication
(10) Pub. No.: US 2025/0123744 A1
(43) Pub. Date: Apr. 17, 2025

(54) DISPLAY METHOD FOR VIRTUAL KEYBOARD, ELECTRONIC DEVICE AND STORAGE MEDIUM

(71) Applicant: GUANGDONG OPPO MOBILE TELECOMMUNICATIONS CORP., LTD., Dongguan (CN)

(72) Inventors: Ke LIANG, Dongguan (CN); Qi CHEN, Dongguan (CN); Mengya DAI, Dongguan (CN); Han LI, Dongguan (CN); Suizi GU, Dongguan (CN)

(73) Assignee: GUANGDONG OPPO MOBILE TELECOMMUNICATIONS CORP., LTD., Dongguan (CN)

(21) Appl. No.: 19/002,501

(22) Filed: Dec. 26, 2024

Related U.S. Application Data
(63) Continuation of application No. PCT/CN2023/100169, filed on Jun. 14, 2023.

(30) Foreign Application Priority Data
Jul. 11, 2022 (CN) 202210853660.9

(51) Int. Cl. G06F 3/04886; G06F 3/0482

(52) U.S. Cl. CPC G06F 3/04886; G06F 3/0482; G06F 2203/04803

(57) ABSTRACT

A display method for a virtual keyboard and an electronic device and a storage medium are provided. The display method includes: displaying the virtual keyboard on an interface; determining, in response to a split operation for the virtual keyboard, a region where virtual keys of a first part of the virtual keyboard are located as a first key region, and a region where virtual keys of a second part of the virtual keyboard are located as a second key region; and adjusting the first key region and the second key region and displaying a functional region between the first key region and the second key region.

### CROSS REFERENCE TO RELATED APPLICATIONS

The present application is a continuation application of International (PCT) Patent Application No. PCT/CN2023/100169, filed on Jun. 14, 2023, which claims priority to Chinese Patent Application No. 202210853660.9, filed on Jul. 11, 2022, the entire contents of which are incorporated herein by reference.

### TECHNICAL FIELD

The present disclosure relates to the technical field of electronic devices, in particular, to a display method for a virtual keyboard, an electronic device, and a storage medium.

### BACKGROUND

With the rapid advancement of technology and living standards, electronic devices (such as smartphones, tablets, etc.) have become one of the most commonly used electronic products in people's daily lives. Currently, screens of electronic devices are becoming increasingly larger, and large-screen electronic devices provide the user with a better visual experience. However, when the user inputs text using large-screen electronic devices, the displayed virtual keyboard also becomes larger. As a result, when the user holds the electronic device to input text, the user needs to move fingers over a large range to touch the corresponding key.

### SUMMARY

The present disclosure provides a display method for a virtual keyboard, an electronic device, and a storage medium.

In a first aspect, some embodiments of the present disclosure provide a display method for a virtual keyboard, including:
displaying the virtual keyboard on an interface;
determining, in response to a split operation for the virtual keyboard, a region where virtual keys of a first part of the virtual keyboard are located as a first key region, and a region where virtual keys of a second part of the virtual keyboard are located as a second key region; and
adjusting the first key region and the second key region and displaying a functional region between the first key region and the second key region;
wherein a width of the first key region after adjustment in a first specified directional dimension is smaller than that of the first key region before adjustment, a width of the second key region after adjustment in the first specified directional dimension is smaller than that of the second key region before adjustment, the first key region after adjustment is located in a first position close to a boundary of the virtual keyboard in a first direction, the second key region after adjustment is located in a second position close to a boundary of the virtual keyboard in a second direction, and the first direction and the second direction are opposite to each other in the first specified directional dimension.

In a second aspect, some embodiments of the present disclosure provide an electronic device, including:
a processor or a plurality of processors;
a memory;
a program or a plurality of programs, wherein the program or programs are stored in the memory and executed by the processor or processors, and the program or programs are configured to implement the method in the first aspect.

In a third aspect, some embodiments of the present disclosure provide a computer-readable storage medium, storing an executable program code, wherein the executable program code is configured to be executed by a processor to implement the method in the first aspect.

### BRIEF DESCRIPTION OF THE DRAWINGS

To more clearly illustrate the technical solutions of the embodiments of the present disclosure, a brief introduction to the drawings used in some embodiments of the present disclosure is provided below. It is evident that the drawings described below are only some of the embodiments of the present disclosure. For those skilled in the art, additional drawings may be derived from these drawings without creative work.

FIG. 1 is a schematic view of an application scenario in some embodiments of the present disclosure.

FIG. 2 is another schematic view of an application scenario in some embodiments of the present disclosure.

FIG. 3 is a flowchart of a display method for a virtual keyboard in some embodiments of the present disclosure.

FIG. 4 is a schematic view of an interface in some embodiments of the present disclosure.

FIG. 5 is a schematic view of an interface in some embodiments of the present disclosure.

FIG. 6 is a schematic view of an interface in some embodiments of the present disclosure.

FIG. 7 is a schematic view of an interface in some embodiments of the present disclosure.

FIG. 8 is a schematic view of an interface in some embodiments of the present disclosure.

FIG. 9 is a schematic view of an interface in some embodiments of the present disclosure.

FIG. 10 is another flowchart of a display method for a virtual keyboard in some embodiments of the present disclosure.

FIG. 11 is another flowchart of a display method for a virtual keyboard in some embodiments of the present disclosure.

FIG. 12 is another schematic view of an interface in some embodiments of the present disclosure.

FIG. 13 is another schematic view of an interface in some embodiments of the present disclosure.

FIG. 14 is another schematic view of an interface in some embodiments of the present disclosure.

FIG. 15 is another flowchart of a display method for a virtual keyboard in some embodiments of the present disclosure.

FIG. 16 is another schematic view of an interface in some embodiments of the present disclosure.

FIG. 17 is another schematic view of an interface in some embodiments of the present disclosure.

FIG. 18 is another schematic view of an interface in some embodiments of the present disclosure.

FIG. 19 is another schematic view of an interface in some embodiments of the present disclosure.

FIG. 20 is another schematic view of an interface in some embodiments of the present disclosure.

FIG. 21 is another flowchart of a display method for a virtual keyboard in some embodiments of the present disclosure.

FIG. 22 is another schematic view of an interface in some embodiments of the present disclosure.

FIG. 23 is another schematic view of an interface in some embodiments of the present disclosure.

FIG. 24 is a block diagram of a display apparatus for a virtual keyboard in some embodiments of the present disclosure.

FIG. 25 is a block diagram of an electronic device configured to execute a display method for a virtual keyboard in some embodiments of the present disclosure.

FIG. 26 is a storage unit configured to store or carry a program code for implementing a display method for a virtual keyboard in some embodiments of the present disclosure.

### DETAILED DESCRIPTION

In order to enable those skilled in the art to better understand the technical solutions of the present disclosure, the technical solutions in the embodiments of the present disclosure will be clearly and comprehensively described below in conjunction with the accompanying drawings.

With the advancement of technology and the growth of user demand, the screen size of the electronic device is becoming increasingly larger. Foldable-screen electronic devices have also emerged, which, when unfolded, may present an even larger screen. When the user plays games or watches videos on large-screen electronic devices, the user has a better visual experience due to the larger picture displayed.

However, with the increasing screen size of the electronic device, when the electronic device is in a scenario for inputting text, the virtual keyboard adapts to the screen size, resulting in a larger size of the virtual keyboard. In this case, when the user holds the electronic device and uses the displayed virtual keyboard for text input, the limited length of the fingers makes the keys in the middle region of the virtual keyboard fall outside the reach of the fingers. As a result, the user has to move the fingers (typically thumbs) over a larger range, leading to a poor user experience during text input.

To address the above issues, a display method for a virtual keyboard, a display apparatus for a virtual keyboard, an electronic device, and a storage medium provided by the present disclosure may enable a distance between virtual keys in the virtual keyboard and an edge of the virtual keyboard along a first specified directional dimension to be reduced. Thus, it is more convenient for the user to touch the virtual keys when the user holds the electronic device to input text. It is also more convenient for the user to input text via the virtual keyboard displayed on the electronic device. The specific display method for the virtual keyboard will be described in detail in subsequent embodiments.

Scenarios involved in some embodiments of the present disclosure are introduced below.

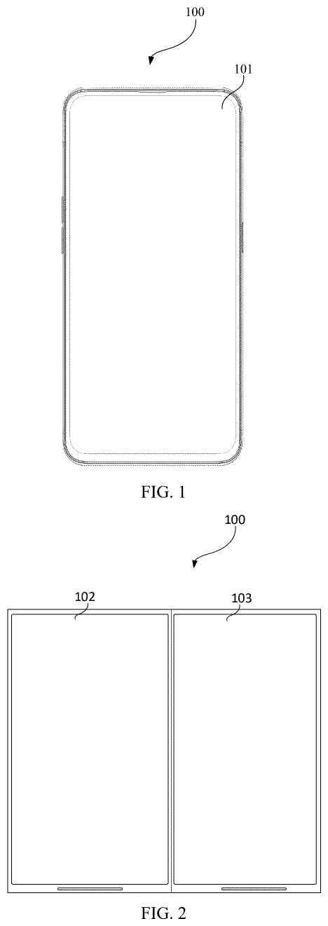

A display method for a virtual keyboard in the present disclosure may be executed by an electronic device. The electronic device may include one display region (e.g., a display screen) or multiple display regions. The multiple display regions may be foldable relative to each other (e.g., foldable screens). For example, as shown in FIG. 1, an electronic device 100 may include one display region 101. Alternatively, for example, as shown in FIG. 2, the electronic device 100 may include a first display region 102 and a second display region 103, with the first display region 102 and the second display region 103 being foldable relative to each other.

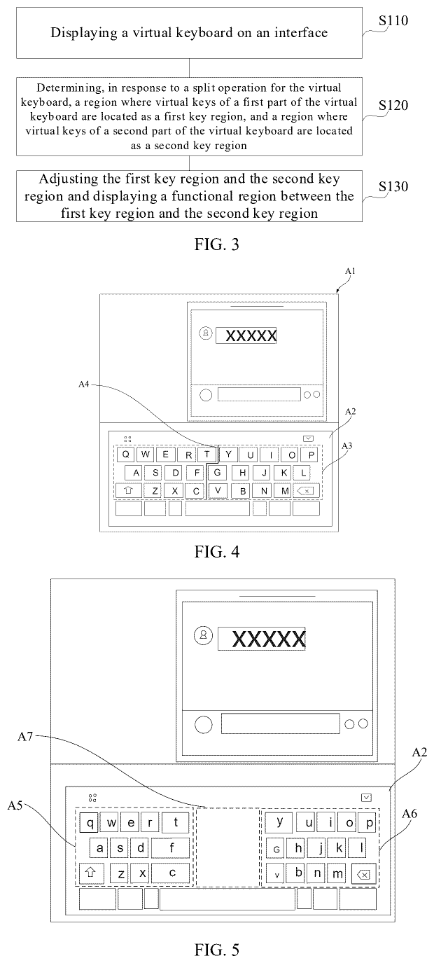

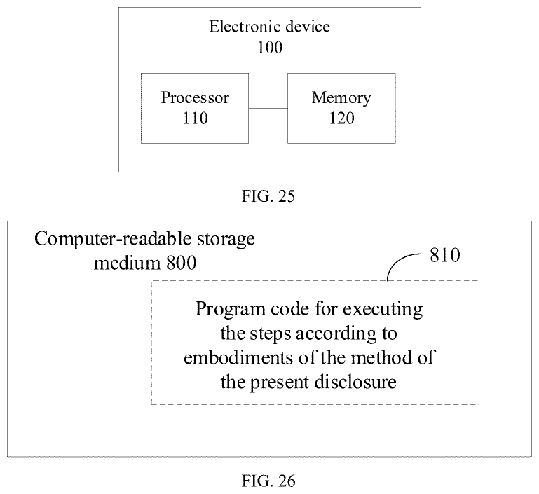

As shown in FIG. 3, FIG. 3 is a flowchart of a display method for a virtual keyboard in some embodiments of the present disclosure. In some embodiments, the display method for the virtual keyboard is applicable to a display apparatus 400 for the virtual keyboard as shown in FIG. 24 and the electronic device 100 (as shown in FIG. 25) configured with the display apparatus 400 for the virtual keyboard. The specific process of some embodiments will be explained using an electronic device as an example. It should be understood that the electronic device may include a smartphone, a tablet, an e-reader, etc. The present disclosure does not limit this. An explanation for the process in FIG. 3 is provided below. The display method for the virtual keyboard may include operations executed by the following blocks.

At block S110, a virtual keyboard is displayed on an interface.

In some embodiments of the present disclosure, the above interface may be any interface capable of invoking the virtual keyboard for text input. For example, when the electronic device runs a memorandum application, the interface may be an editing interface of an item in a memorandum. In condition of detecting an input operation for an input region, the virtual keyboard may be displayed on the interface, enabling the user to input text using the virtual keyboard. Alternatively, as shown in FIG. 4, when the electronic device runs a chat application, the interface may be a chat interface A1. In condition of detecting the input operation for the input region, a virtual keyboard A2 may be displayed on the chat interface A1. The present disclosure does not limit the specific interfaces. For example, the interfaces may also include a text message editing interface, an input interface for a browser, etc.

At block S120, in response to a split operation for the virtual keyboard, a region where virtual keys of a first part of the virtual keyboard are located is determined as a first key region. A region where virtual keys of a second part of the virtual keyboard are located is determined as a second key region.

In some embodiments of the present disclosure, in a case where the virtual keyboard is displayed on a current interface, the electronic device, when detecting the split operation for the virtual keyboard, after splitting the virtual keys in the virtual keyboard, adjusts a display of the virtual keyboard. The virtual keys in the virtual keyboard may be split into two parts. The region where the virtual keys of the first part of the virtual keyboard are located is determined as the first key region, and the region where the virtual keys of the second part of the virtual keyboard are located is determined as the second key region.

In some embodiments, the virtual keyboard may include a trigger control for triggering a split of the virtual keyboard. When the electronic device detects an operation on the trigger control, the electronic device is determined to detect the split operation for the virtual keyboard. The trigger control may be displayed in a non-key region of the virtual keyboard. For example, the trigger control may be displayed on an upper edge or a lower edge of the virtual keyboard.

In some embodiments, when the electronic device detects a predetermined trigger gesture for the virtual keyboard, the electronic device is determined to detect the split operation for the virtual keyboard. That is, when the electronic device detects the predetermined trigger gesture for the virtual keyboard, the electronic device is determined to obtain split position information for the virtual keys in the virtual keyboard and subsequent steps in order to realize the adjustment of the display of the virtual keyboard, which is convenient for the user to input via the virtual keyboard.

In some embodiments, when the electronic device detects a first press operation at a first position of the virtual keyboard, and a second press operation at a second position of the virtual keyboard, the electronic device is determined to detect the split operation for the electronic device. In some embodiments, the first position may be located at a region where a left edge of the virtual keyboard is located, and the second position may be located at a region where a right edge of the virtual keyboard is located. By simultaneously detecting the first press operation at the region where the left edge of the virtual keyboard is located and the region where the right edge of the virtual keyboard is located, the split operation may be quickly triggered. In some embodiments, the aforementioned first press operation and second press operation may satisfy a predetermined press condition. The predetermined press condition may include at least one of the following: a press duration of the first press operation and/or the second press operation exceeding a predetermined duration, a press area of the first press operation and/or the second press operation exceeding a predetermined area, and a press force of the first press operation and/or the second press operation exceeding a predetermined force. The present disclosure does not limit this.

In some embodiments, when the electronic device detects a first sliding operation at a third position of the virtual keyboard and a second sliding operation at a fourth position of the virtual keyboard, the electronic device is determined to detect the split operation for the electronic device. The third position is different from the fourth position. A touch region of a starting position of the first sliding operation and a touch region of a starting point of the second sliding operation respectively include at least two virtual keys. It should be understood that, due to a large number of keys on the virtual keyboard, touching an individual key may easily result in accidental input. Therefore, by requiring the electronic device to detect at least two sliding operations on each touch region of the starting position so as to trigger a switch for a keyboard mode, it may quickly trigger the split operation for the virtual keyboard while avoiding accidental inputs. The first sliding operation and the second sliding operation may be performed simultaneously or non-simultaneously. For example, an interval between the second sliding operation and the first sliding operation may be less than a predetermined duration. The predetermined duration may be 0.5 seconds, 1 second, 2 seconds, etc.

In some embodiments, when the electronic device detects a shake operation performed on itself, the electronic device is determined to detect the split operation for the virtual keyboard. The shake operation involves shaking a body of the electronic device. The electronic device may be arranged with a motion sensor. The electronic device may detect the shake operation by the motion sensor. The motion sensor may include at least one of a gravity sensor, an accelerometer, a gyroscope, or a six-axis sensor (or nine-axis sensor or twelve-axis sensor) combined the accelerometer and the gyroscope.

In some embodiments, the motion sensor arranged in the electronic device may include the gravity sensor and the gyroscope. The gravity sensor operates based on a piezoelectric effect, where a mass is integrated with a piezoelectric plate inside the gravity sensor. By measuring voltages generated in two orthogonal directions, a horizontal orientation may be calculated. When the gravity sensor is arranged in the electronic device, the gravity sensor is typically configured to switch between landscape and portrait orientations. The gyroscope is also known as an angular velocity sensor. The electronic device is typically configured with a three-axis gyroscope, which may track movement in six directions and acquire angular accelerations in x, y, and z directions. This allows precise measurement for rotations and tilts of the electronic device, enabling appropriate operations to be performed on the electronic device. In the electronic device, applications involving the gyroscope usually include a game, a camera stabilization, a navigation, etc. The electronic device may use the gyroscope to detect when it is rotated at a certain angle and use the gravity sensor to detect when it is tilted due to gravity, thereby determining that the shake operation has been detected.

In some embodiments, when the electronic device detects the shake operation and a shake amplitude of the electronic device exceeds a predetermined amplitude, the electronic device is determined to detect the split operation for the virtual keyboard. The electronic device may use the gyroscope to measure rotation angles along various axes and determine the shake amplitude of the electronic device.

In some embodiments, the electronic device splits the virtual keys of the virtual keyboard into two parts. This splitting may apply to all virtual keys in an entire key region or only to virtual keys in a specific part of a key region. Moreover, a key region to be split includes at least one row of virtual keys.

In some embodiments, the electronic device may split the virtual keys in the virtual keyboard along a direction of a second specified directional dimension into the first part of the virtual keys and the second part of the virtual keys and thus obtain the first key region and the second key region. Through subsequent control of a display width and a display position, the virtual keys in the first key region and the virtual keys in second key region may be positioned close to corresponding side edges of the virtual keyboard. This arrangement makes it easier for the user to touch the virtual keys in the first key region and the virtual keys in the second key region. The second specified direction dimension may be a column directional dimension formed by the virtual keys in the virtual keyboard or, may be understood as a vertical dimension from the user's perspective while operating the electronic device.

In some embodiments, the electronic device may determine the region where the virtual keys of the first part of the virtual keyboard are located as the first key region and the region where the virtual keys of the second part of the virtual keyboard are located as the second key region based on a detected user operation. In other words, the user may split the virtual keys in the virtual keyboard according to the user's needs and habits.

In some embodiments, the electronic device may also split the virtual keys in the virtual keyboard based on predetermined split position information and determine the first key region and the second key region.

In some embodiments, after the electronic device splits the virtual keys in the virtual keyboard into two parts, for the virtual keys of the first part, relative positions among the virtual keys of the first part may remain unchanged, and the region they located are is used as the first key region. Similarly, for the virtual keys of the second part, relative positions among the virtual keys of the second part may remain unchanged, and the region they located are is used as the second key region. Through subsequent display adjustments, as the relative positions of the virtual keys remain unchanged, the user's input habits may not be affected. Alternatively, the electronic device may also rearrange the virtual keys of the first part to obtain the first key region, and rearrange the virtual keys of the second part to obtain the second key region. In this method, a number of rows of the virtual keys in the first key region may still be kept consistent with an original number of rows in the virtual keyboard, as is a number of rows in the second key region. This ensures that subsequent display adjustments neither reduce nor add rows of the virtual keys to the virtual keyboard, thereby ensuring aesthetics.

The present disclosure does not limit the specific method for splitting the virtual keys in a target region, as long as the virtual keys in the target region are divided into two parts, with each part serving as a new key region. Furthermore, since the virtual keyboard includes at least one row of the virtual keys, subsequent display adjustment steps may reduce a distance between the virtual keys in the target region and the corresponding side edges of the virtual keyboard respectively.

At block S130, the first key region and the second key region are adjusted, and a functional region is displayed between the first key region and the second key region.

In some embodiments, after the electronic device determines the first key region and the second key region, the electronic device may adjust the first key region and the second key region and display the functional region between the first key region and the second key region. The adjustment of the first key region and the second key region may involve adjusting their widths in the first specified directional dimension and their display positions within the virtual keyboard, enabling a width of the first key region after adjustment in the first specified directional dimension to be smaller than a width of the first key region before adjustment, and a width of the second key region after adjustment in the first specified directional dimension to be smaller than a width of the second key region before adjustment. The first key region after adjustment is located in the first position close to a boundary of the virtual keyboard in a first direction. The second key region after adjustment is located in the second position close to a boundary of the virtual keyboard in a second direction. The first direction and the second direction are directions within the first specified directional dimension but opposite to each other. The first specified directional dimension may be a row directional dimension formed by the virtual keys in the virtual keyboard or may be understood as a horizontal dimension from the user's perspective when using the electronic device.

It can be understood that, as the widths of the first key region and the second key region in the first specified directional dimension are reduced, and the first key region and the second key region are thus close to the boundary of the virtual keyboard in opposite directions along the first specified directional dimension, the distance between the virtual keys in the first key region and the boundary of the virtual keyboard in the first specified directional dimension is reduced, and the distance between the virtual keys in the second key region and the boundary of the virtual keyboard in the first specified directional dimension is reduced. That is, the virtual keys in the virtual keyboard are positioned close to the edges on both sides of the keyboard, enabling the user to easily reach and interact with the virtual keys.

Additionally, as the widths of the first key region and the second key region in the first specified directional dimension are reduced, a blank region is formed between the first key region and the second key region. The functional region may be displayed within the blank region between the first key region and the second key region to enable additional operations from the user to be performed when the user is using the keyboard to input.

In some embodiments, when the electronic device reduces the widths of the first key region and the second key region in the first specified directional dimension, it may respectively reduce them to a respective predetermined width. The predetermined width may be a default display width or a display width predetermined by the electronic device based on user's configuration settings. The present disclosure does not limit this.

In some embodiments, it is possible that a key edge of the virtual keys in the first key region and a key edge of the virtual keys in the second key region at the split position (the virtual keys at a side edge close to a middle position of the virtual keyboard) are not aligned in the second specified directional dimension. This may affect the aesthetics after adjusting the displays. Therefore, in this case, the widths of the virtual keys in the first key region and the second key region may be adjusted in the first specified directional dimension so that the key edges of the first key region and the second key region close to side edges of the middle position are aligned and displayed in a vertical direction.

For example, referring to FIGS. 4 and 5, as shown in FIG. 4, a key region A3 of the virtual keyboard may include a row where the virtual key ‘Q’ is located, a row where the virtual key ‘A’ is located and a row where the virtual key ‘Z’ is located. When the split position information is a split trajectory A4 shown in FIG. 4, then as shown in FIG. 5, a first key region A5 and a second key region A6 may be obtained by splitting the virtual keys in the key region A3 based on the split trajectory A4. After a width of the first key region A5 in the first specified directional dimension and a width of the second key region A6 in the first specified directional dimension are reduced, the first key region A5 is displayed on the virtual keyboard at the first position, which is close to the boundary of the virtual keyboard in the first direction, and the second key region A6 is displayed on the virtual keyboard at the second position, which is close to the boundary of the virtual keyboard in the second direction. This reduces the distance between the virtual keys in the key region and the two side boundaries of the virtual keyboard in the first specified directional dimension. Additionally, a functional region A7 is displayed between the first key region A5 and the second key region A6 to meet the user's additional operational needs when the user is using the keyboard to input.

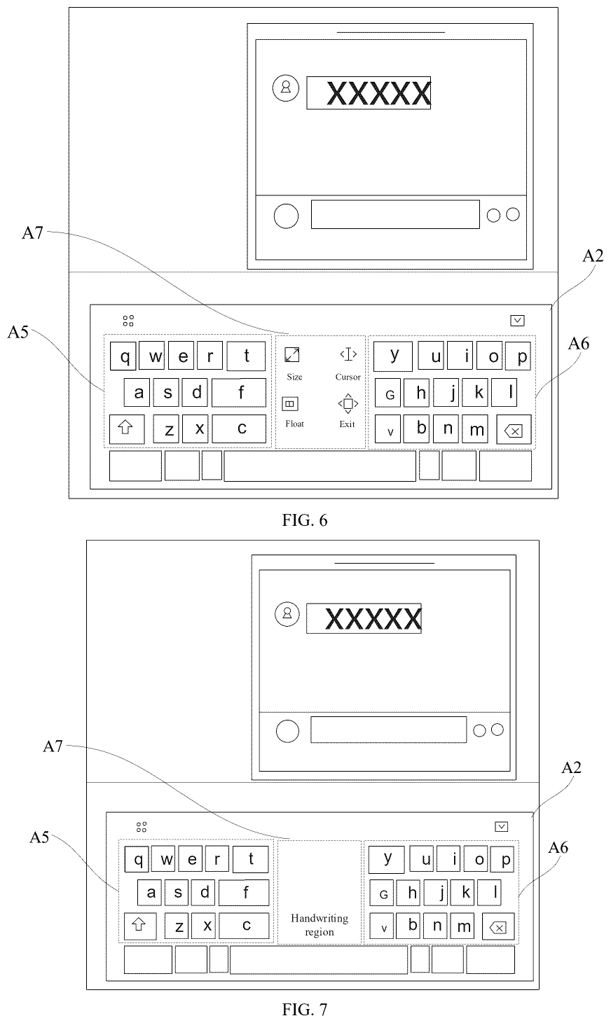

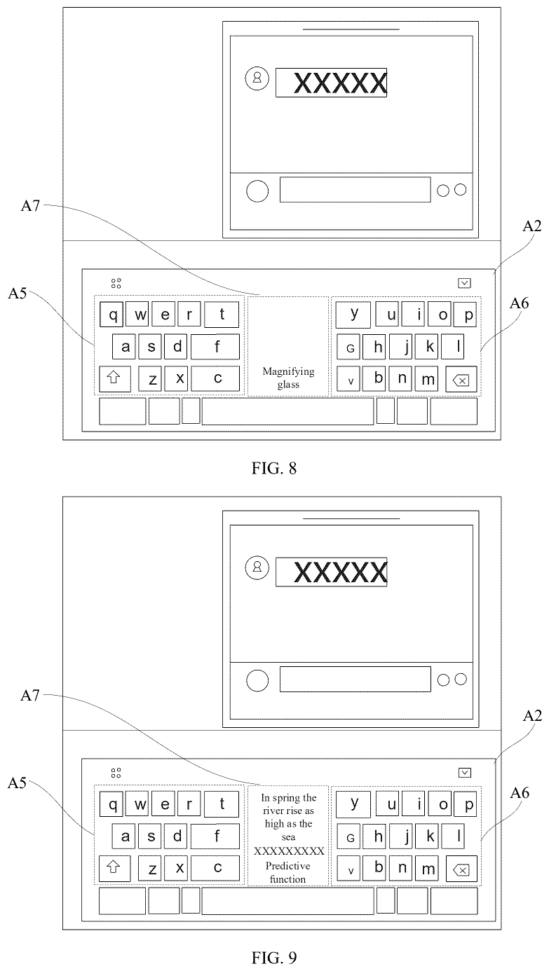

In some embodiments, the functional region may be configured to achieve multiple functions. The multiple functions may be set according to user settings. For example, as shown in FIG. 6, the functional region A7 may include multiple function controls. The multiple function controls may include a control for adjusting a display size of the virtual keyboard, a control for controlling a cursor, a control for controlling the virtual keyboard to be floatingly displayed, a control for exiting a current split keyboard mode, etc. Alternatively, as shown in FIG. 7, the functional region A7 may also be a handwriting region, enabling the user to input content through handwriting. Further, as shown in FIG. 8, the functional region A7 may also be configured to implement a magnifying glass function. Based on the user's operation for the functional region, a display for an editing content may be magnified or shrunk, etc. Additionally, as shown in FIG. 9, the functional region A7 may be configured to implement a predictive function. When detecting the user is inputting text through the virtual keyboard, it may predict a next likely input based on the text inputted, and display a predicted content in the functional region for the user to review and select. The specific function implemented by the functional region is not limited to the examples above. For example, the functional region may also be configured to display an image corresponding to a status of the electronic device. For example, when the electronic device is a foldable screen mobile terminal, the functional region may display an image of a flower blooming when the foldable screen is in an unfolded state. When the electronic device is in a folded state, the functional region may display an image of a closed flower. Additionally, the functional region may also be configured to perform image and text recognition, etc.

The display method for the virtual keyboard provided by the present disclosure, by splitting the virtual keys into two parts, reduces the widths of the first key region and the second key region in the first specified directional dimension and the first key region and the second key region are respectively close to the corresponding edge of the virtual keyboard in opposite directions along the first specified directional dimension. This reduces the distance between the virtual keys and edges of the virtual keyboard in the first specified dimension. That is, when the user holds the electronic device with both hands for text input, the user may more conveniently reach the virtual key, thus facilitating text input by the user using the virtual keyboard displayed on the electronic device.

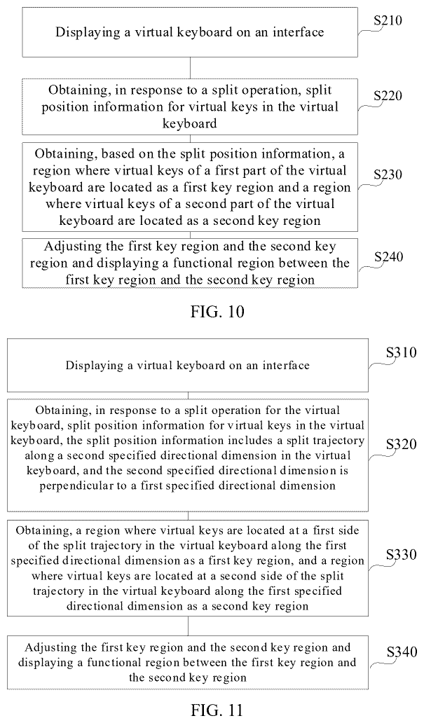

As shown in FIG. 10, FIG. 10 is another flowchart of a display method for a virtual keyboard in some embodiments of the present disclosure. The display method for the virtual keyboard is applicable to the aforementioned electronic device. The process shown in FIG. 10 will be described below in detail. The display method for the virtual keyboard may include operations executed by the following blocks.

At block S210, a virtual keyboard is displayed on an interface.

In some embodiments of the present disclosure, the block 210 may be referred to contents in other embodiments, which will not repeated here.

At block S220, in response to a split operation for the virtual keyboard, split position information of the virtual keys in the virtual keyboard is obtained.

In some embodiments of the present disclosure, when the electronic device displays the virtual keyboard on the interface and detects the split operation for the virtual keyboard, the electronic device may obtain the split position information of the virtual keys in the virtual keyboard. Based on the split position information, the electronic device, after splitting the virtual keys in the virtual keyboard, adjusts the display of the virtual keyboard. The split position information includes position information of the virtual keys which is configured to split the virtual keys in the virtual keyboard into two parts. The virtual keyboard may be a virtual keyboard formed by virtual keys in a predetermined key region, or a virtual keyboard formed by the virtual keys in a key region selected based on a user operation, and the virtual keyboard includes at least one row of the virtual keys. In some embodiments, the split position information may include a split trajectory, at least one key position, etc.

In some embodiments, the electronic device obtains the split position information for the virtual keys of the virtual keyboard based on the detected user operation. In other words, the user may split the virtual keys of the virtual keyboard according to the user's need and preference.

In some embodiments, the electronic device may be pre-configured with split position information corresponding to each split method in the multiple split methods. The split position information corresponding to each split method in the multiple split methods is different. The multiple split methods may be predetermined in the electronic device or customized by the user. The present disclosure does not limit this. In some embodiments, when the electronic device obtains the split position information for the virtual keys in the virtual keyboard, it may display options corresponding to the multiple split methods. Based on a selection operation from the user, it may select any of the split methods and obtain the split position information corresponding to the split method selected as current split position information for the virtual keys in the virtual keyboard. In some embodiments, based on a predetermined determination operation from the user, the electronic device may determine a selected split method as a default split method from the multiple split methods. When the electronic device obtains the split position information for the virtual keys in the virtual keyboard, it may directly take the split position information corresponding to the default split method as the split position information for the virtual keys in the virtual keyboard.

The specific method by which the electronic device obtains the split location information for the virtual keys in the virtual keyboard is not limited by the present disclosure.

At block S230, based on the split position information, a region where virtual keys of the first part of the virtual keyboard are located is obtained as the first key region, and a region where virtual keys of the second part of the virtual keyboard are located is obtained as the second key region.

In some embodiments, after obtaining the split position information, the electronic device may split the virtual keys in the virtual keyboard into two parts based on the splitting position information and obtain the region where the virtual keys of the first part of the virtual keyboard are located as the first key region, and the region where the virtual keys of the second part of the virtual keyboard are located as the second key region.

In some embodiments, based on the split position information, the electronic device may split the virtual keys in the virtual keyboard along the direction of the second specified directional dimension into the first part of the virtual keys and the second part of the virtual keys and thus obtain the first key region and the second key region. Through subsequent control of the display width and the display position, the virtual keys in the first key region and the second key region may be positioned close to two side edges of the virtual keyboard. This arrangement makes it easier for the user to touch the virtual keys in the first key region and the second key region. The second specified direction dimension may be a column direction dimension formed by the virtual keys in the virtual keyboard or may be understood as the vertical dimension from the user's perspective when using the electronic device.

In some embodiments, the split position information may be a position of a virtual key. In this case, the virtual keys in the virtual keyboard may be split into the first part of the virtual keys and the second part of the virtual keys based on a vertical line in the second specified directional dimension at the position of the virtual keys. The split position information may be a split trajectory inputted. The split trajectory is along the second specified directional dimension. The virtual keys in the virtual keyboard may be directly split into the virtual keys of the first part and the virtual keys of the second part. The split position information may also be an irregular split trajectory for the virtual keys in the virtual keyboard. The virtual keys in the virtual keyboard may be directly split into the virtual keys of the first part and the virtual keys of the second part. In some embodiments, through splitting along the second specified directional dimension, it may ensure that after subsequent adjustments, the relative positions of the virtual keys in the target region remain unchanged, thus the user's input habits may not be affected.

At block S240, the first key region and the second key region are adjusted, and the functional region is displayed between the first key region and the second key region.

The width of the first key region after adjustment in the first specified directional dimension is smaller than the width of the first key region before adjustment. The width of the second key region after adjustment in the first specified directional dimension is smaller than the width of the second key region before adjustment. The first key region after adjustment is located in the first position close to the boundary of the virtual keyboard in the first direction. The second key region after adjustment is located in the second position close to the boundary of the virtual keyboard in the second direction. The first direction and the second direction are opposite to each other in the first specified directional dimension.

In some embodiments of the present disclosure, the block 240 may be referred to in other embodiments, which will not be repeated here.

The display method for the virtual keyboard provided by the present disclosure may enable the distance between the virtual keys in the virtual keyboard and the edge of the virtual keyboard along the first specified directional dimension to be reduced. Thus, it is more convenient for the user to touch the virtual keys when the user holds the electronic device to input text. It is also more convenient for the user to input text via the virtual keyboard displayed on the electronic device. In addition, the electronic device may split the virtual keys in the virtual keyboard based on different split position information, thereby satisfying the input habits of different users.

As shown in FIG. 11, FIG. 11 is another flowchart of a display method for a virtual keyboard in some embodiments of the present disclosure. The display method for the virtual keyboard is applicable to the electronic device in the aforementioned embodiments of the present disclosure. An explanation for the process in FIG. 11 is provided below. The display method for the virtual keyboard may include operations executed by the following blocks.

At block S310, the virtual keyboard is displayed on the interface.

At block S320, in response to the split operation for the virtual keyboard, the split position information for the virtual keys in the virtual keyboard is obtained. The split position information includes the split trajectory along the second specified directional dimension in the virtual keyboard. The second specified directional dimension is perpendicular to the first specified directional dimension.

In some embodiments of the present disclosure, the block 310 and the block 320 may be referred to in other embodiments, which will not be repeated here.

In some embodiments, the first specified directional dimension may be the row directional dimension formed by the virtual keys in the virtual keyboard or may be understood as the horizontal dimension from the user's perspective when using the electronic device. The second specified directional dimension may be the column direction dimension formed by the virtual keys in the virtual keyboard or may be understood as the vertical dimension from the user's perspective when using the electronic device.

At block S330, a region where the virtual keys are located at a first side of the split trajectory in the virtual keyboard along the first specified directional dimension is obtained as the first key region, and a region where the virtual keys are located at a second side of the split trajectory in the virtual keyboard along the first specified directional dimension is obtained as the second key region.

In some embodiments, the split position information may be a split trajectory along the second specified directional dimension. For example, as shown in FIG. 4, the key region A3 of the virtual keyboard may include the row where the virtual key ‘Q’ is located, the row where the virtual key ‘A’ is located, and the row where the virtual key ‘Z’ is located. The split position information may be the split trajectory A4 as shown in FIG. 4. Based on this, the electronic device may obtain the region where the virtual keys are located at the first side of the split trajectory in the virtual keyboard along the first specified directional dimension as the first key region, and the region where the virtual keys are located at the second side of the split trajectory in the virtual keyboard along the first directional dimension as the second key region. In other words, from the user's viewing perspective when using the electronic device, since the split trajectory is a line along the second specified directional dimension, the electronic device may obtain the region where the virtual keys are located at the first side of the split trajectory in the virtual keyboard along the first specified directional dimension as the first key region, and the region where the virtual keys are located at the second side of the split trajectory in the virtual keyboard along the first directional dimension as the second key region.

In some embodiments, considering that when a user inputs the split position information, the split trajectory inputted by the user may not be located in a gap between the virtual keys, directly splitting key regions based on the virtual keys on the left side of the split trajectory and the virtual keys on the right side of the split trajectory may result in missing the virtual keys in the target region that are precisely located on the split trajectory. To address this, the electronic device may determine whether a position of the split trajectory of the virtual keyboard has virtual keys existing therein. In a case that a position of the split trajectory of the virtual keyboard has virtual keys existing therein, the virtual keys located at the position of the split trajectory are obtained as target keys. The electronic device may obtain the region where the virtual keys are located at the first side of the split trajectory in the virtual keyboard along the first specified directional dimension along with the target keys as the first key region, and the region where the virtual keys are located at the second side of the split trajectory in the virtual keyboard along the first directional dimension along with the target keys as the second key region.

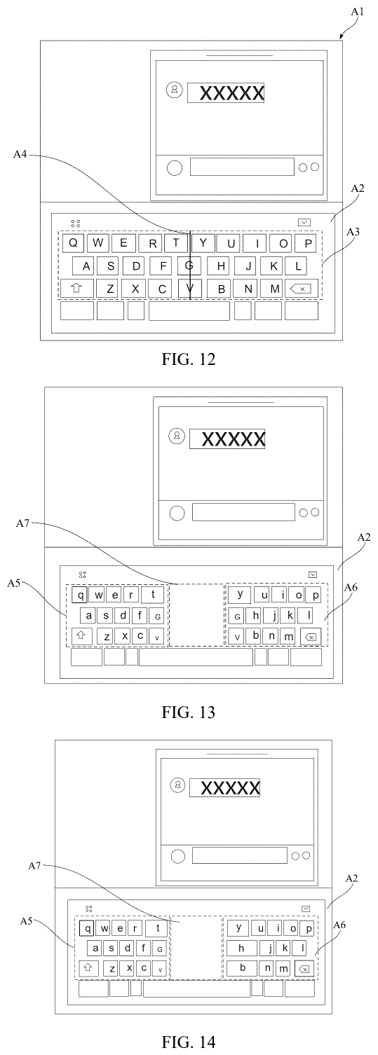

In other words, in some embodiments, when the split trajectory happens to intersect a virtual key in the target region, the virtual key may be assigned to both the first key region and the second key region. After subsequent display adjustments, the target key may be displayed in both the first key region and the second key region. For example, as shown in FIG. 12, the key region A3 of the virtual keyboard may include the row where the virtual key ‘Q’ is located, the row where the virtual key ‘A’ is located and the row where the virtual key ‘Z’ is located. When a split line A4 intersects a virtual key ‘G’ and a virtual key ‘V’, as shown in FIG. 13, both the virtual key ‘G’ and the virtual key ‘V’ may be assigned to both the first key region A5 and the second key region A6. Through the process of block S240, both the first key region A5 and the second key region A6 may display the virtual key ‘G’ and the virtual key ‘V’.

In some embodiments, the electronic device may determine whether the position of the split trajectory of the virtual keyboard has virtual keys existing therein. When the position of the split trajectory of the virtual keyboard has virtual keys existing therein, the virtual keys located at the position of the split trajectory are identified as the target keys. The electronic device may obtain the region where the virtual keys are located at the first side of the split trajectory in the virtual keyboard along the first specified directional dimension along with the target keys as the first key region, and the region where the virtual keys are located at the second side of the split trajectory in the virtual keyboard along the first directional dimension as the second key region.

In other words, in some embodiments, when the split trajectory intersects a virtual key in the target region, the virtual key may be assigned to the first key region. After subsequent display adjustments, the target key may be displayed in the first key region and may not be displayed in the second key region. For example, as shown in FIG. 12, the key region A3 of the virtual keyboard may include the row where the virtual key ‘Q’ is located, the row where the virtual key ‘A’ is located and the row where the virtual key ‘Z’ is located. When the split line A4 intersects the virtual key ‘G’ and the virtual key ‘V’, as shown in FIG. 14, both the virtual key ‘G’ and the virtual key ‘V’ may be assigned to the first key region A5. Through the process of block S240, the first key region A5 may display the virtual key ‘G’ and the virtual key ‘V’ and the second key region A6 may not display the virtual key ‘G’ and the virtual key ‘V’.

In some embodiments, the electronic device may determine whether the position of the split trajectory of the virtual keyboard has virtual keys existing therein. When the position of the split trajectory of the virtual keyboard has virtual keys existing therein, the virtual keys located at the position of the split trajectory are identified as the target keys. The electronic device may obtain the region where the virtual keys are located at the first side of the split trajectory in the virtual keyboard along the first specified directional dimension as the first key region, and the region where the virtual keys are located at the second side of the split trajectory in the virtual keyboard along the first specified directional dimension along with the target keys as the second key region.

In other words, in some embodiments, when the split trajectory intersects a virtual key in the target region, the virtual key may be assigned to the second key region. After subsequent display adjustments, the target key may be displayed in the second key region and may not be displayed in the first key region. For example, as shown in FIG. 12, the key region A3 of the virtual keyboard may include the row where the virtual key ‘Q’ is located, the row where the virtual key ‘A’ is located and the row where the virtual key ‘Z’ is located. The split line A4 intersects the virtual key ‘G’ and the virtual key ‘V’. In this case, as shown in FIG. 5, both the virtual key ‘G’ and the virtual key ‘V’ may be assigned to the second key region A6 Through the process of block S240, the second key region A6 may display the virtual key ‘G’ and the virtual key ‘V’ and the first key region A5 may not display the virtual key ‘G’ and the virtual key ‘V’.

It should be noted that the three aforementioned embodiments may be combined. For example, the electronic device may selectively assign the target keys to the first key region, the second key region, or to both the first key region and the second key region based on the user's selection operation.

At block S340, the first key region and the second key region are adjusted, the functional region is displayed between the first key region and the second key region.

The width of the first key region after adjustment in the first specified directional dimension is smaller than the width of the first key region before adjustment, and the width of the second key region after adjustment in the first specified directional dimension is smaller than the width of the second key region before adjustment. The first key region after adjustment is located in the first position close to the boundary of the virtual keyboard in the first direction. The second key region after adjustment is located in the second position close to the boundary of the virtual keyboard in the second direction. The first direction and the second direction are directions within the first specified directional dimension but opposite to each other.

The block S340 may be referred to in other embodiments, which will not be repeated here. The display method for the virtual keyboard provided by the present disclosure may enable a distance between the virtual keys in the virtual keyboard and the boundary of the virtual keyboard along the first specified directional dimension to be reduced. Thus, it is more convenient for the user to touch the virtual keys when the user holds the electronic device to input text. It is also more convenient for the user to input text via the virtual keyboard displayed on the electronic device. In addition, the electronic device may split the virtual keys in the virtual keyboard based on different split position information, thereby satisfying the input habits of different users. Furthermore, based on the actual position of the split line in the virtual keyboard, the electronic device determines the virtual keys in the first key region and the virtual keys in the second key region, which may achieve a better separation of the virtual keyboard.

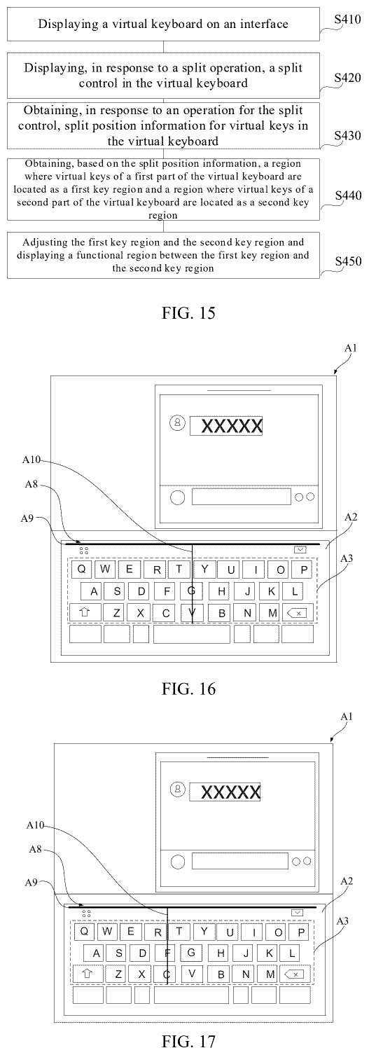

As shown in FIG. 15, FIG. 15 is another flowchart of a display method for a virtual keyboard in some embodiments of the present disclosure. An explanation for the process in FIG. 15 is provided below. The display method for virtual keyboard may include operations executed by the following blocks.

At block S410, the virtual keyboard is displayed on the interface.

In some embodiments of the present disclosure, the block 410 may be referred to in other embodiments, which will not be repeated here.

At block S420, in response to the split operation for the virtual keyboard, a split control is displayed in the virtual keyboard.

In some embodiments, in response to the split operation for the virtual keyboard, when the electronic device obtains the split position information of the virtual keys in the virtual keyboard, the electronic device may display the split control in the virtual keyboard. The split control may be configured to split the virtual keys in the virtual keyboard. Thus, the user may utilize the split control to split the virtual keys based on the user's habits and requirements.

In some embodiments, in response to the split operation for the virtual keyboard, the electronic device may control the virtual keyboard into an editable state. When the virtual keyboard of the electronic device is in the editable state, the split control may be displayed in the virtual keyboard. The split control may be a movable floating indicator block, a slider bar, etc. The present disclosure does not limit specific types of split controls.

At block S430, in response to an operation for the split control, the split position information of the virtual keys in the virtual keyboard is obtained.

In some embodiments, after the electronic device displays the split control in the virtual keyboard, the electronic device may detect the operation for the split control. When the electronic device detects the operation for the split control, in response to the operation for the split control, the electronic device obtains the split position information of the virtual keys in the virtual keyboard.

In some embodiments, the split control may be the slider bar. The slider bar is parallel to the first specified directional dimension. The slider bar includes a sliding track and a sliding block. The sliding block may move along the sliding track based on the user's sliding operation. Based on this, in response to the first sliding operation for the sliding block of the slider bar, the electronic device may control the sliding block to slide along the sliding track of the slider bar in a direction of the first sliding operation. Based on a position where the sliding block stops sliding, the split position information for the virtual keys in the virtual keyboard is determined.

In some embodiments, based on the position where the sliding block stops sliding, the electronic device may determine a straight line in the second specified directional dimension (a line perpendicular to the row direction) at the position where the sliding block stops sliding. The straight line may be used as the split trajectory. Therefore, the split position information for the virtual keys in the virtual keyboard may be determined.

In some embodiments, the sliding block may be an indicator line along the second specified directional dimension. The indicator line spans across all rows of the virtual keyboard. After the first sliding operation is completed, the indicator line may be directly used as the split trajectory and thereby obtaining the split position information for the virtual keys in the virtual keyboard.

For example, as shown in FIG. 16, the key region A3 to be split of the virtual keyboard may include the row where the virtual key ‘Q’ is located, the row where the virtual key ‘A’ is located and the row where the virtual key ‘Z’ is located. A slider bar A8 is displayed in the virtual keyboard A2. The slider bar A8 includes a sliding track A9 and an indicator line A10 as the sliding block. As shown in FIG. 13, when the user uses the sliding operation to slide the indicator line A10 to stop at a position shown in FIG. 16, the indicator line A10 is used to determine the first key region A5 and the second key region A6. After the width of the first key region A5 in the first specified directional dimension and the width of the second key region A6 in the first specified directional dimension are reduced, the first key region A5 is displayed on the virtual keyboard at the first position, which is close to the boundary of the virtual keyboard in the first direction, and the second key region A6 is displayed on the virtual keyboard at the second position, which is close to the boundary of the virtual keyboard in the second direction. This reduces the distance between the virtual keys in the key region and the two boundaries of the virtual keyboard in the first specified directional dimension. Additionally, a functional region A7 is displayed between the first key region A5 and the second key region A6 to meet the user's additional operational needs when the user is using the keyboard to input.

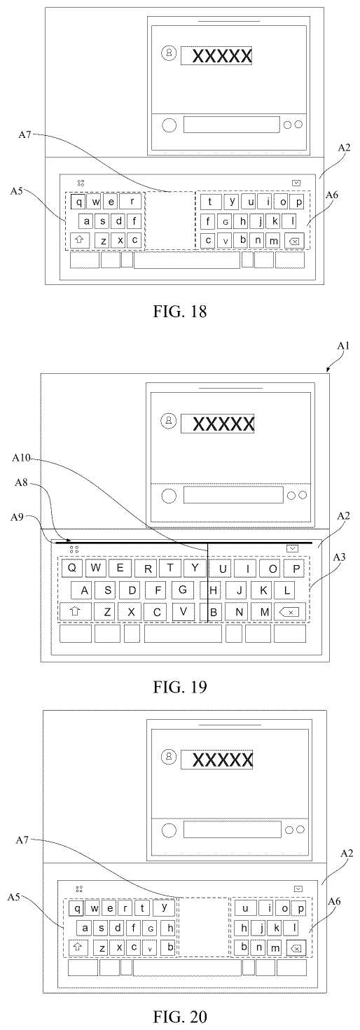

For example, as shown in FIG. 17, the key region A3 to be split of the virtual keyboard may include the row where the virtual key ‘Q’ is located, the row where the virtual key ‘A’ is located and the row where the virtual key ‘Z’ is located. A slider bar A8 is displayed in the virtual keyboard A2. The slider bar A8 includes a sliding track A9 and an indicator line A10 as the sliding block. As shown in FIG. 18, when the user uses the sliding operation to slide the indicator line A10 to stop at a position shown in FIG. 17, the indicator line A10 is used to determine the first key region A5 and the second key region A6. After the width of the first key region A5 in the first specified directional dimension and the width of the second key region A6 in the first specified directional dimension are reduced, the first key region A5 is displayed on the virtual keyboard at the first position, which is close to the boundary of the virtual keyboard in the first direction, and the second key region A6 is displayed on the virtual keyboard at the second position, which is close to the boundary of the virtual keyboard in the second direction. This reduces the distance between the virtual keys in the key region and the two boundaries of the virtual keyboard in the first specified directional dimension. Additionally, the functional region A7 is displayed between the first key region A5 and the second key region A6 to meet the user's additional operational needs when the user is using the keyboard to input.

For example, as shown in FIG. 19, the key region A3 to be split of the virtual keyboard may include the row where the virtual key ‘Q’ is located, the row where the virtual key ‘A’ is located and the row where the virtual key ‘Z’ is located. A slider bar A8 is displayed in the virtual keyboard A2. The slider bar A8 includes a sliding track A9 and an indicator line A10 as the sliding block. As shown in FIG. 20, when the user uses the sliding operation to slide the indicator line A10 to stop at a position shown in FIG. 19, the indicator line A10 is used to determine the first key region A5 and the second key region A6. After the width of the first key region A5 in the first specified directional dimension and the width of the second key region A6 in the first specified directional dimension are reduced, the first key region A5 is displayed on the virtual keyboard at the first position, which is close to the boundary of the virtual keyboard in the first direction, and the second key region A6 is displayed on the virtual keyboard at the second position, which is close to the boundary of the virtual keyboard in the second direction. This reduces the distance between the virtual keys in the key region and the two boundaries of the virtual keyboard in the first specified directional dimension. Additionally, the functional region A7 is displayed between the first key region A5 and the second key region A6 to meet the user's additional operational needs when the user is using the keyboard to input.

From the examples above, it is evident that the user may operate the slider bar based on user needs to satisfy different input habits. For example, as shown in FIG. 18, a number of the virtual keys on the right side of the key region A3 to be split is greater than a number of the virtual keys on the left side of the key region A3 to be split. This is beneficial for the user who is right-handed when using the keyboard to input. As shown in FIG. 20, the number of the virtual keys on the left side of the key region A3 to be split is greater than the number of the virtual keys on the right side of the key region A3 to be split. This is beneficial for the user who is left-handed when using the keyboard to input.

In some embodiments, the split control may be an indicator control that is movable, such as the movable floating indicator block, etc. The electronic device may detect the operation for the indicator control. When the electronic device detects the sliding operation for the indicator control, in response to the second sliding operation for the indicator control, the electronic device may control the indicator control to move along a move trajectory of the second sliding operation. Based on a move trajectory of the indicator control, the split position information of the virtual keys in the virtual keyboard is determined. In some embodiments, the move trajectory of the indicator control may be used as the split trajectory, thereby obtaining the split position information of the virtual keys in the virtual keyboard. This enables the user to move the indicator control to perform the split operation on the virtual keyboard.

In some embodiments, when the electronic device controls the indicator control to move along the slide trajectory of the second sliding operation, the electronic device may also display the move trajectory of the indicator control, thereby enabling the user to know about a position of the split trajectory.

At block S440, based on the split position information, the region where virtual keys of a first part of the virtual keyboard are located is obtained as the first key region, and the region where virtual keys of a second part of the virtual keyboard are located is obtained as the second key region.

At block S450, the first key region and the second key region are adjusted, and the functional region is displayed between the first key region and the second key region.

The width of the first key region after adjustment in the first specified directional dimension is smaller than the width of the first key region before adjustment. The width of the second key region after adjustment in the first specified directional dimension is smaller than the width of the second key region before adjustment. The first key region after adjustment is located in the first position close to the boundary of the virtual keyboard in the first direction. The second key region after adjustment is located in the second position close to the boundary of the virtual keyboard in the second direction. The first direction and the second direction are opposite to each other in the first specified directional dimension.

In some embodiments of the present disclosure, the block S440 and the block S450 may be referred to in other embodiments, which will not be repeated here.

The display method for the virtual keyboard provided by the present disclosure may enable the distance between the virtual keys in the virtual keyboard and the boundary of the virtual keyboard along the first specified directional dimension to be reduced. Thus, it is more convenient for the user to touch the virtual keys when the user holds the electronic device to input text. It is also more convenient for the user to input text via the virtual keyboard displayed on the electronic device. In addition, when determining the split position information of the virtual keys in the virtual keyboard, by displaying the split control and based on the operation for the split control, the electronic device may determine the split position information, thereby satisfying input habits of different users.

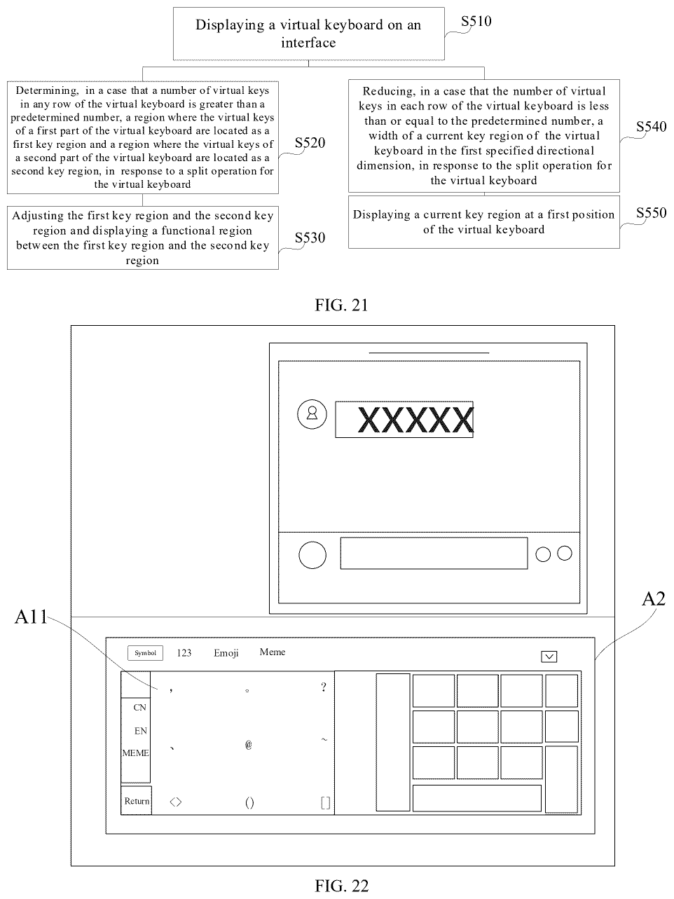

As shown in FIG. 21, FIG. 21 is another flowchart of a display method for a virtual keyboard in some embodiments of the present disclosure. An explanation for the process in FIG. 21 is provided below. The display method for the virtual keyboard may include operations executed by the following blocks.

At block 510, the virtual keyboard is displayed on the interface.

In some embodiments of the present disclosure, the block 510 may be referred to in other embodiments, which will not be repeated here.

At block S520, in response to the split operation for the virtual keyboard, when a number of the virtual keys in any row of the virtual keyboard is greater than a predetermined number, the region where the virtual keys of the first part of the virtual keyboard are located is determined as the first key region, and the region where the virtual keys of the second part of the virtual keyboard are located is determined as the second key region.

In some embodiments of the present disclosure, in response to the split operation for the virtual keyboard, the electronic device may determine whether the number of the virtual keys in any row of a current virtual keyboard exceeds the predetermined number. When the number of the virtual keys in any row exceeds the predetermined number, it represents a need to split a key region of the current virtual keyboard. Otherwise, it represents that there is no need to split the key region of the current virtual keyboard. When the user holds the electronic device and the number of the virtual keys arranged in the same row exceeds the predetermined number, it represents the number of the row includes too many virtual keys and there is a need to split. The present disclosure does not limit the predetermined number. For example, the predetermined number may be 5, 7, 8, etc. It should be understood that the virtual keyboard displayed in the electronic device may include two types, a 26-key keyboard for English and Chinese, which is also known as a QWERTY keyboard, and a 9-key keyboard. In the QWERTY keyboard, a number of keys in the same row is relatively high, while in the 9-key keyboard, a number of keys in the same row is relatively smaller, which does not exceed 5. The 9-key keyboard in the present disclosure, generally does not need to split the key region. Therefore, when the number of the virtual keys in any row exceeds the predetermined number, the electronic device may perform operations executed by the block of determining the region where the virtual keys of the first part of the virtual keyboard are located as the first key region, and the region where the virtual keys of the second part of the virtual keyboard are located as the second key region to block S530. This enables the width of the first key region and the width of the second key region to be reduced after the virtual keys in the virtual keyboard are split into two parts. This further enables the first key region and the second key region to respectively to be close to the corresponding boundary of the virtual keyboard in opposite directions along the first specified directional dimension.

At block S530, the first key region and the second key region are adjusted, and the functional region is displayed between the first key region and the second key region.

The width of the first key region after adjustment in the first specified directional dimension is smaller than the width of the first key region before adjustment. The width of the second key region after adjustment in the first specified directional dimension is smaller than the width of the second key region before adjustment. The first key region after adjustment is located in the first position close to the boundary of the virtual keyboard in the first direction. The second key region after adjustment is located in the second position close to the boundary of the virtual keyboard in the second direction. The first direction and the second direction are opposite to each other in the first specified directional dimension.

In some embodiments of the present disclosure, the block S530 may be referred to in other embodiments, which will not be repeated here.

At block S540, in response to the split operation for the virtual keyboard, when the number of the virtual keys in each row of the virtual keyboard is less than or equal to the predetermined number, the width of a current key region of the virtual keyboard is reduced in the first specified directional dimension.

In some embodiments, in response to the split operation, when the number of the virtual keys in each row of the virtual keyboard is less than or equal to the predetermined number, there is no need to split the key region of the virtual keyboard. In this case, a display width of the current key region of the virtual keyboard may be directly reduced. For example, when the current virtual keyboard is the 9-key keyboard, the width of the current key region of the virtual keyboard in the first specified directional dimension may be directly reduced.

In some embodiments, when the electronic device reduces the width of the current key region of the virtual keyboard in the first specified directional dimension, the electronic device may reduce the width to a target display width. The target display width may be a default display width or a width predetermined by the electronic device based on the user's configuration settings. The present disclosure does not limit this.

At block S550, the current key region is displayed at the first position of the virtual keyboard.

In some embodiments of the present disclosure, the electronic device may further display the current key region at the aforementioned first position, which is a location close to the boundary of the virtual keyboard in one of the directions along the first specified directional dimension. This reduces the display width of the current key region and displays the current key region on a side of the two sides of the virtual keyboard in the first specified directional dimension. In other words, from the user's perspective, by displaying the current key region of the virtual keyboard on the left side or the right side of the virtual keyboard, the virtual keys in the current key region may be closer to a side where the virtual keyboard is located, thus facilitating the user's input by the keyboard.

In some embodiments, when the electronic device displays the current key region at the first position, the electronic device may also display a functional menu region at the second position in the virtual keyboard. This enables the user to easily touch the virtual keys in an original key area while enabling the user to perform other operations at the second position of the virtual keyboard, thereby further enhancing the user experience.

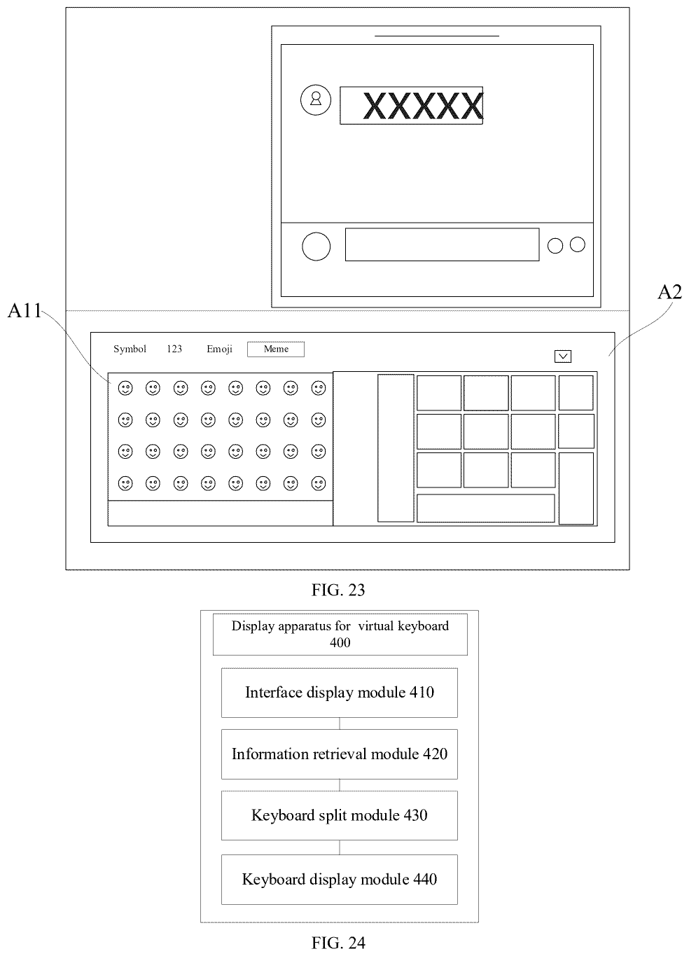

In some embodiments, the functional menu region includes a secondary page corresponding to functional keys of the virtual keyboard. The functional key may include keys for an emoji, a symbol, a number, etc. The functional key refers to the functional page corresponding to each of the functional keys. In some embodiments, the second side of the virtual keyboard may display multiple functional keys and the corresponding secondary page of a currently selected functional key. For example, as shown in FIG. 22, when the currently selected functional key is the symbol, a secondary page A11 displays multiple symbols. For example, as shown in FIG. 23, when the currently selected functional key is the emoji, the secondary page A11 displays multiple emojis.

In some embodiments, when the electronic device displays the current key region at the first position of the virtual keyboard, which corresponds to a side of the virtual keyboard in the row direction, the electronic device may also obtain a holding state of the electronic device. When the holding state of the electronic device satisfies a predetermined holding condition, the electronic device determines the first direction based on a side of the electronic device being held, and determines the first position. The current key region is subsequently displayed at the first position of the virtual keyboard. The first direction in the first specified directional dimension corresponds to the side of the electronic device being held. The predetermined holding condition is defined based on a state of the electronic device when it is held with one hand. For example, the predetermined holding condition may be that a side of the electronic device is being touched, and/or a touched area is smaller than a predetermined area. Specific predetermined holding conditions are not limited and may vary.

In some embodiments, a housing of the electronic device may be arranged with a pressure sensor, a touch sensor, etc. By utilizing a sensor arranged on the housing, the electronic device may detect information such as a touched area, a touched position, etc., thereby determining the holding state of the electronic device.

In some embodiments, when the holding state of the electronic device satisfies a condition corresponding to the electronic device not being held or a condition corresponding to the electronic device being held with both hands, the electronic device may determine the first direction based on the user's dominant hand, and consequently, determine the first position.

In some embodiments, the user's dominant hand generally has different pressing parameters during a touch interaction, such as a different pressure or a different touched area. As a result, when the user inputs using the keyboard, the pressing parameters for keys in different regions of the virtual keyboard will differ when touched. Based on this, when values of the pressing parameters (e.g., pressure, touched area, etc.) for the virtual keys in the left region are greater than the virtual keys in the right region, it may be determined that the user prefers to use the left hand for keyboard input. When values of the pressing parameters (e.g., pressure, touched area, etc.) for the virtual keys in the right region are greater than the virtual keys in the left region, it may be determined that the user prefers to use the right hand for keyboard input. Based on the dominant hand, the electronic device may display the current key region on a side corresponding to the dominant hand. For example, when the dominant hand is the right hand, the first direction may be determined to correspond to the right side of the virtual keyboard. When the dominant hand is the left hand, the first direction may be determined to correspond to the left side of the virtual keyboard.

In some embodiments, the electronic device may obtain a user profile from external devices such as a server. The user profile may include dominant hand information of the user. Based on the dominant hand information obtained from the user profile, the current key region may be displayed on a side corresponding to the user's dominant hand.

In some embodiments, considering that the same electronic device may be used by multiple users, the electronic device may pre-store biometric features (e.g., a facial recognition, a fingerprint, etc.) of different users. The electronic device may identify a target user currently using the electronic device based on the pre-stored biometric features and determine the dominant hand of the target user based on the aforementioned methods.

The display method for the virtual keyboard provided by the present disclosure may enable the distance between the virtual keys in the virtual keyboard and the boundary of the virtual keyboard along the first specified directional dimension to be reduced. Thus, it is more convenient for the user to touch the virtual keys when the user holds the electronic device to input text. It is also more convenient for the user to input text via the virtual keyboard displayed on the electronic device. In addition, the method adopts different approaches for different types of virtual keyboards to make it easier for the user to touch the virtual key, further enhancing the convenience of using the keyboard for input.

As shown in FIG. 24, FIG. 24 is a block diagram of a display apparatus for a virtual keyboard in some embodiments of the present disclosure. A display apparatus 400 for a virtual keyboard is applied to the aforementioned electronic device. The display apparatus 400 for the virtual keyboard includes an interface display module 410, an information retrieval module 420, a keyboard split module 430, and a keyboard display module 440. The interface display module 410 is configured to display the virtual keyboard on the interface. The information retrieval module is configured to retrieve the split position information of the virtual keys in the virtual keyboard. The keyboard split module 430 is configured to determine the region where the virtual keys of the first part of the virtual keyboard are located as the first key region and the region where the virtual keys of the second part of the virtual keyboard are located as the second key region in response to the split operation for the virtual keyboard. The keyboard display module 440 is configured to adjust the first key region and the second key region and display the functional region between the first key region and the second key region. The width of the first key region after adjustment in the first specified directional dimension is smaller than the width of the first key region before adjustment. The width of the second key region after adjustment in the first specified directional dimension is smaller than the width of the second key region before adjustment. The first key region after adjustment is located in the first position close to the boundary of the virtual keyboard in the first direction. The second key region after adjustment is located in the second position close to the boundary of the virtual keyboard in the second direction. The first direction and the second direction are opposite to each other in the first specified directional dimension.

In some embodiments, the information retrieval module 420 may include an information retrieval unit and the keyboard split module 430 may include a split unit. The information retrieval unit is configured to obtain the split position information of the virtual keys in the virtual keyboard in response to the split operation for the virtual keyboard. The split unit is configured to obtain the region where the virtual keys of the first part of the virtual keyboard are located as the first key region, and region where the virtual keys of the second part of the virtual keyboard are located as the second key region based on the split position information.

In some embodiments, the split position information includes the split trajectory along the second specified directional dimension in the virtual keyboard. The second specified directional dimension is perpendicular to the first specified directional dimension. The split unit may be configured to obtain the region where the virtual keys are located at the first side of the split trajectory in the virtual keyboard along the first specified directional dimension as the first key region, and the region where the virtual keys are located at the second side of the split trajectory in the virtual keyboard along the first specified directional dimension as the second key region.

In some embodiments, the split unit may be configured to obtain, in a case that a position of the split trajectory of the virtual keyboard has virtual keys existing therein, the virtual keys located at the position of the split trajectory as target keys, and to obtain the region where the virtual keys are located at the first side of the split trajectory in the virtual keyboard along the first specified directional dimension along with the target keys as the first key region, and the region where the virtual keys are located at the second side of the split trajectory in the virtual keyboard along the first specified directional dimension along with the target keys as the second key region.

In some embodiments, the information retrieval unit may be configured to display the split control on the virtual keyboard in response to the split operation for the virtual keyboard, and obtain the split position information for the virtual keys in the virtual keyboard in response to the operation for the split control.

In some embodiments, the split control may be the slider bar. The slider bar is parallel to the first specified directional dimension. The information retrieval unit may be configured to control the sliding block to slide along the sliding track of the slider bar in the direction of the first sliding operation in response to the first sliding operation and determine the split position information for the virtual keys in the virtual keyboard based on the position where the sliding block stop sliding.

In some embodiments, the split control may be the indicator control that is movable. The information retrieval unit may be further configured to in response to the second sliding operation for the indicator control, control the indicator control to move along the slide trajectory of the second sliding operation, and determine the split position information for the virtual keys in the virtual keyboard based on the move trajectory of the indicator control.

In some embodiments, the keyboard split module 430 may be further configured to in response to the split operation for the virtual keyboard, when a number of the virtual keys in any row of the virtual keyboard exceeds a predetermined number, the region where the virtual keys of the first part of the virtual keyboard are located are determined as the first key region, and the region where the virtual keys of the second part of the virtual keyboard are located is determined as the second key region.

In some embodiments, the keyboard display module 440 may be further configured to in response to the split operation for the virtual keyboard, when the number of the virtual keys in each row of the virtual keyboard is less than or equal to the predetermined number, the width of the current key region of the virtual keyboard is reduced in the first specified directional dimension.

In some embodiments, the keyboard display module 440 may be further configured to display the current key region at the first position in the virtual keyboard and display the functional menu region at the second position in the virtual keyboard where the current key region is displayed.

In some embodiments, the functional menu region includes the secondary page corresponding to functional keys of the virtual keyboard.

In some embodiments, the keyboard display module 440 may be further configured to obtain the holding state of the virtual keyboard in the row, when the holding state of the electronic device satisfies the predetermined holding condition, determine the first direction based on the side of the electronic device being held, and display the current key region at the first position of the virtual keyboard.

Those skilled in the art may clearly understand that, for the simplicity of description, the specific working processes of the aforementioned described devices and modules may refer to the corresponding processes in the method embodiments described earlier, and thus will not be repeated here.

In some embodiments of the present disclosure, the coupling between the modules may be electrical, mechanical, or in other forms of coupling.

Additionally, in some embodiments of the present disclosure, the functional modules may be integrated into a single processing module, exist physically as separate modules, or have two or more modules integrated into a single module. The integrated modules may be implemented in the form of hardware or as software functional modules.

In the technical solutions provided by the present disclosure, in response to the split operation for the virtual keyboard, the region where the virtual keys of the first part of the virtual keyboard are located, is determined as the first key region, and the region where the virtual keys of the second part of the virtual keyboard are located, is determined as the second key region. The electronic device may adjust the first key region and the second key region and display the functional region between the first key region and the second key region. After splitting the virtual keyboard into two parts and adjusting the first key region and the second key region, the width of the first key region after adjustment in the first specified directional dimension is smaller than the width of the first key region before adjustment, and the width of the second key region after adjustment in the first specified directional dimension is smaller than the width of the second key region before adjustment. This enables the first key region and the second key region to be close to the corresponding boundary of the virtual keyboard in opposite directions along the first specified directional dimension. This reduces the distance between the virtual keys and the corresponding edge of the virtual keyboard in the first specified dimension. That is, when the user holds the electronic device with both hands for text input, the user may more conveniently reach the virtual keys, thus facilitating text input by the user using the virtual keyboard displayed on the electronic device.

As shown in FIG. 25, FIG. 25 is a block diagram of an electronic device configured to execute a display method for a virtual keyboard in some embodiments of the present disclosure. An electronic device 100 may be a smartphone, a tablet, an e-book reader or other electronic devices capable of running applications. The electronic device 100 in the present disclosure may include one or more of a processor 110, one or more of a memory 120, and one or more application programs, which may be stored in the memory 120 and configured to be executed by one or more of the processor 110. The one or more application programs may be configured to execute the methods described in the above embodiments.

The processor 110 may include one or more processing cores. The processor 100 connects various parts of the electronic device 100 via interfaces and circuits. By running or executing instructions, programs, code sets, or instruction sets stored in the memory 120, and by invoking data stored in the memory 120, the processor 110 performs various functions of the electronic device 100 and processes data. In some embodiments, the processor 110 may be implemented in at least one hardware form, such as a digital signal processing (DSP), a field-programmable gate array (FPGA), a programmable logic array (PLA). The processor 110 may integrate one or a combination of a central processing unit (CPU), a graphics processing unit (GPU), a modem, etc. The CPU is configured to handle an operating system, a user interface, an application, etc. The GPU is configured to be responsible for rendering and drawing display content. The modem is configured to handle a wireless communication. It should be understood that the modem may also be implemented as a separate communication chip instead of being integrated into the processor 110.

The memory 120 may include a random access memory (RAM) and a read-only memory (ROM). The memory 120 may be configured to store instructions, programs, code, code sets, or instruction sets. The memory 120 may include a program storage area and a data storage area. The program storage area is configured to store instructions to implement the operating system, instructions to implement at least one function (e.g., a touch function, an audio playback function, a video playback function, etc.), and instructions to implement the methods in the embodiments described below. The data storage area may be configured to store data generated during the running of the electronic device 100 (e.g., a phone book, audio and video data, chat history, etc.).

As shown in FIG. 26, FIG. 26 is a storage unit configured to store or carry a program code for implementing a display method for a virtual keyboard in some embodiments of the present disclosure. A computer-readable storage medium 800 stores a program code, which may be invoked by the processor to execute the methods described in the aforementioned embodiments.

The computer-readable storage medium 800 may be an electronic storage medium such as a flash memory, an electrically erasable programmable read-only memory (EEPROM), an erasable programmable read-only memory (EPROM), a hard disk, a ROM, etc. In some embodiments, the computer-readable storage medium 800 may include a non-transitory computer-readable storage medium. The computer-readable storage medium 800 includes a storage space configured to store the program code 810, which is configured to execute any of the methods described above. The program code may be read from or written to one or more computer program products. The program code 810 may be compressed into an appropriate form.

It should be noted that the above embodiments are only for illustrating the technical solutions of the present disclosure and are not intended to limit them. Though the present disclosure has been described in detail with reference to the aforementioned embodiments, those skilled in the art should understand that the technical solutions described in these embodiments can be modified, or certain technical features can be equivalently substituted. These modifications or substitutions will not depart from the essence and scope of the technical solutions of the present disclosure.

What is claimed is:

1. A display method for a virtual keyboard, applicable to an electronic device, and the method comprising:
displaying the virtual keyboard on an interface;
determining, in response to a split operation for the virtual keyboard, a region where virtual keys of a first part of the virtual keyboard are located as a first key region, and a region where virtual keys of a second part of the virtual keyboard are located as a second key region; and
adjusting the first key region and the second key region and displaying a functional region between the first key region and the second key region;
wherein a width of the first key region after adjustment in a first specified directional dimension is smaller than that of the first key region before adjustment, a width of the second key region after adjustment in the first specified directional dimension is smaller than that of the second key region before adjustment, the first key region after adjustment is located in a first position close to a boundary of the virtual keyboard in a first direction, the second key region after adjustment is located in a second position close to a boundary of the virtual keyboard in a second direction, and the first direction and the second direction are opposite to each other in the first specified directional dimension.

2. The method as claimed in claim 1, wherein the determining, in response to the split operation for the virtual keyboard, the region where the virtual keys of the first part of the virtual keyboard are located as the first key region, and the region where the virtual keys of the second part of the virtual keyboard are located as the second key region, comprises:
obtaining, in response to the split operation for the virtual keyboard, split position information for the virtual keys in the virtual keyboard; and
obtaining, based on the split position information, the region where the virtual keys of the first part of the virtual keyboard are located as the first key region, and the region where the virtual keys of the second part of the virtual keyboard are located as the second key region.

3. The method as claimed in claim 2, wherein the split position information comprises a split trajectory along a second specified directional dimension in the virtual keyboard, and the second specified directional dimension is perpendicular to the first specified directional dimension;
the obtaining, based on the split position information, the region where the virtual keys of the first part of the virtual keyboard are located as the first key region, and the region where the virtual keys of the second part of the virtual keyboard are located as the second key region, comprises:
obtaining, a region where the virtual keys are located at a first side of the split trajectory in the virtual keyboard along the first specified directional dimension as the first key region, and a region where the virtual keys are located at a second side of the split trajectory in the virtual keyboard along the first specified directional dimension as the second key region.

4. The method as claimed in claim 3, wherein the obtaining, the region where the virtual keys are located at the first side of the split trajectory in the virtual keyboard along the first specified directional dimension as the first key region, and the region where the virtual keys are located at the second side of the split trajectory in the virtual keyboard along the first specified directional dimension as the second key region, comprises:
obtaining, in a case that a position of the split trajectory of the virtual keyboard has virtual keys existing therein, the virtual keys located at the position of the split trajectory as target keys;
obtaining a region where the virtual keys are located at the first side of the split trajectory in the virtual keyboard along the first specified directional dimension and the target keys as the first key region; and
obtaining a region where the virtual keys are located at the second side of the split trajectory in the virtual keyboard along the first specified directional dimension and the target keys as the second key region.

5. The method as claimed in claim 2, wherein the obtaining, in response to the split operation for the virtual keyboard, the split position information for the virtual key in the virtual keyboard, comprises:
displaying, in response to the split operation for the virtual keyboard, a split control in the virtual keyboard; and
obtaining, in response to an operation for the split control, the split position information for the virtual keys in the virtual keyboard.

6. The method as claimed in claim 5, wherein the split control is a slider bar, the slider bar is parallel to the first specified directional dimension, and
the obtaining, in response to the operation for the split control, the split position information for the virtual key in the virtual keyboard, comprises:
controlling, in response to a first sliding operation for a sliding block of the slider bar, the sliding block to slide in a sliding track of the slider bar along a sliding direction of the first sliding operation; and
determining, based on a position where the sliding block stops sliding, the split position information for the virtual keys in the virtual keyboard.

7. The method as claimed in claim 5, wherein the split control is an indicator control that is movable, and
the obtaining, in response to the operation for the split control, the split position information for the virtual key in the virtual keyboard, comprises:
controlling, in response to a second sliding operation for the indicator control, the indicator control to move along a move trajectory of the second sliding operation; and
determining, based on the move trajectory of the indicator control, the split position information for the virtual keys in the virtual keyboard.

8. The method as claimed in claim 1, wherein the determining, in response to the split operation for the virtual keyboard, the region where the virtual key of the first part in the virtual keyboard is located as the first key region, and the region where the virtual key of the second part in the virtual keyboard is located as the second key region, comprises:
executing, in a case that a number of virtual keys in any row of the virtual keyboard is greater than a predetermined number, the determining the region where the virtual keys of the first part of the virtual keyboard are located as the first key region, and the region where the virtual keys of the second part of the virtual keyboard are located as the second key region, in response to the split operation for the virtual keyboard.

9. The method as claimed in claim 8, wherein the method further comprises:
reducing, in a case that the number of virtual keys in each row of the virtual keyboard is less than or equal to the predetermined number, a width of a current key region of the virtual keyboard in the first specified directional dimension, in response to the split operation for the virtual keyboard; and
displaying the current key region at the first position of the virtual keyboard.

10. The method as claimed in claim 9, wherein the displaying the current key region at the first position of the virtual keyboard, comprises:
displaying the current key region at the first position of the virtual keyboard and displaying a functional menu region at the second position of the virtual keyboard where the current key region is displayed.

11. The method as claimed in claim 10, wherein the functional menu region comprises a secondary page corresponding to functional keys of the virtual keyboard.

12. The method as claimed in claim 9, wherein the displaying the current key region at the first position of the virtual keyboard, comprises:
obtaining a holding state of the electronic device;
determining, in a case that the holding state of the electronic device satisfies a predetermined holding condition, the first position based on a side where the electronic device is held; and
displaying the current key region at the first position of the virtual keyboard.

13. The method as claimed in claim 1, wherein key edges of the first key region and the second key region close to side edges of a middle position of the virtual keyboard respectively, are aligned in the second specified directional dimension and displayed.

14. The method as claimed in claim 1, wherein a trigger control for triggering a split of the virtual keyboard, and the determining, in response to the split operation for the virtual keyboard, the region where the virtual keys of the first part of the virtual keyboard are located as the first key region, and the region where the virtual keys of the second part of the virtual keyboard are located as the second key region, further comprises:
determining, in case of detecting an operation for the trigger control, the split operation for the virtual keyboard is detected.

15. The method as claimed in claim 1, wherein before the determining, in response to the split operation for the virtual keyboard, the region where the virtual keys of the first part of the virtual keyboard are located as the first key region, and the region where the virtual keys of the second part of the virtual keyboard are located as the second key region, the method further comprises:
determining, in case of detecting a predetermined trigger gesture for the virtual keyboard, the split operation for the virtual keyboard is detected.

16. The method as claimed in claim 1, wherein before the determining, in response to the split operation for the virtual keyboard, the region where the virtual keys of the first part of the virtual keyboard are located as the first key region, and the region where the virtual keys of the second part of the virtual keyboard are located as the second key region, the method further comprises:
determining, in case of detecting a shake operation for the virtual keyboard, the split operation for the virtual keyboard is detected.

17. The method as claimed in claim 16, wherein the determining, in case of detecting a shake operation for the virtual keyboard, the split operation for the virtual keyboard is detected, further comprises:
determining, in case of detecting a shake operation for the virtual keyboard and in case of detecting a shake amplitude of the shake operation exceeding a predetermined amplitude, the split operation for the virtual keyboard is detected.

18. The method as claimed in claim 9, wherein the displaying the current key region at the first position of the virtual keyboard, comprises:
obtaining a holding state of the electronic device;
determining, in a case that the holding state of the electronic device satisfies a condition corresponding to the electronic device not being held or a condition corresponding to the electronic device being held with both hands, the first position based on a dominant hand; and
displaying the current key region at the first position of the virtual keyboard.

19. An electronic device, comprising:
a processor or a plurality of processors;
a memory;
a program or a plurality of programs, wherein the program or programs are stored in the memory and executed by the processor or processors, and the program or programs are configured to implement:
displaying the virtual keyboard on an interface;
determining, in response to a split operation for the virtual keyboard, a region where virtual keys of a first part of the virtual keyboard are located as a first key region, and a region where virtual keys of a second part of the virtual keyboard are located as a second key region; and
adjusting the first key region and the second key region and displaying a functional region between the first key region and the second key region;
wherein a width of the first key region after adjustment in a first specified directional dimension is smaller than that of the first key region before adjustment, a width of the second key region after adjustment in the first specified directional dimension is smaller than that of the second key region before adjustment, the first key region after adjustment is located in a first position close to a boundary of the virtual keyboard in a first direction, the second key region after adjustment is located in a second position close to a boundary of the virtual keyboard in a second direction, and the first direction and the second direction are opposite to each other in the first specified directional dimension.

20. A computer-readable storage medium, storing an executable program code, wherein the executable program code is configured to be executed by a processor to implement:
displaying the virtual keyboard on an interface;
determining, in response to a split operation for the virtual keyboard, a region where virtual keys of a first part of the virtual keyboard are located as a first key region, and a region where virtual keys of a second part of the virtual keyboard are located as a second key region; and
adjusting the first key region and the second key region and displaying a functional region between the first key region and the second key region;
wherein a width of the first key region after adjustment in a first specified directional dimension is smaller than that of the first key region before adjustment, a width of the second key region after adjustment in the first specified directional dimension is smaller than that of the second key region before adjustment, the first key region after adjustment is located in a first position close to a boundary of the virtual keyboard in a first direction, the second key region after adjustment is located in a second position close to a boundary of the virtual keyboard in a second direction, and the first direction and the second direction are opposite to each other in the first specified directional dimension.
